(19) United States
(12) Patent Application Publication
(10) Pub. No.: US 2004/0114598 A1
(43) Pub. Date: Jun. 17, 2004

(54) Radio link protocol sync procedure

(76) Inventors: Sivaramakrishna Veerepalli, San Diego, CA (US); Baaziz Achour, San Diego, CA (US); Sai Yiu Duncan Ho, San Diego, CA (US); Lei Shen, San Diego, CA (US); Nischal Abrol, San Diego, CA (US)

Correspondence Address: Qualcomm Incorporated, Patents Department, 5775 Morehouse Drive, San Diego, CA, 92121-1714, US

(21) Appl. No.: 10/317,907

(22) Filed: Dec. 11, 2002

(51) Int. Cl. H04L 12/56

(52) U.S. Cl. 370/394; 370/389

(57) ABSTRACT

To mitigate re-syncs, RLP sync control frames associated with a packet data session can be sequence numbered. A single sequence number can be assigned for an entire sync procedure associated with the initiation of a packet data session. For example, the sequence number can remains the same on all sync control frames (SYNC, SYNC/ACK, ACK) of a particular packet data session. When a sync frame is received out of order within a single sequence, it can be ignored under certain conditions. For example, if a SYNC frame with a sequence number 0 is received out of order after an ACK frame with sequence number 0 is received, the mobile station can ignore the out of order SYNC frame. Thus, an RLP re-sync is avoided due to out of order RLP sync packets.

### BACKGROUND

1. Field

The present invention relates generally to wireless communications, and more specifically to a protocol for wireless communication.

2. Background

The forward packet data channel (F-PDCH) of IS-2000, Release C (also known as cdma2000 1x-EVDV) consists of multiple Hybrid Automatic Repeat Request (HARQ) logical channels. The logic channels can be time division multiple access (TDMA) channels, each channel being assigned a time slot of the F-PDCH.

Each receiving wireless communication device (WCD) can be assigned one or more of the HARQ logical channels. Sub-packets destined for the receiving WCD can be assigned to the HARQ channels. A transmitting WCD can transmit the assigned sub-packets over the corresponding HARQ channels.

The communication protocol defined by cdma2000 1xEV-DV comprises, among other layers, a Radio Link Protocol (RLP) Layer and a Physical (PHY) Layer. The RLP Layer provides RLP frames, which are in turn encoded and provided to the PHY Layer. At the PHY Layer, the data in the RLP frames are encoded into sub-packets for transmission over the HARQ channels,

The RLP frames can be sync control frames. Sync control frames are used to establish communication at the beginning of a packet data session between the transmitting WCD and the receiving WCD. After sync is established, data packets can be sent during the session.

In an RLP sync procedure, the transmitting WCD and receiving WCD participate in a symmetric three-way handshake procedure. The procedure can comprise of the two WCDs exchanging RLP sync control frames. The sync control frames can comprise SYNC frames, SYNC/ACK frames, and ACK frames.

For example, a receiving WCD, such as a mobile cellular telephone, can initiate a packet data session by the user pressing the SEND button of the mobile cellular telephone. In response, the transmitting WCD, such as a cellular base station serving a sector that covers the geographic region that the mobile cellular telephone is within, can send SYNC frames over the HARQ channels. Typically, the base station sends multiple redundant SYNC frames to establish a reliable packet data session with the mobile station.

In response to the receipt and recovery of a SYNC frame, the mobile cellular telephone can send a corresponding SYNC/ACK frame. The SYNC/ACK frame indicates the SYNC frame was recovered.

When the base station recovers a SYNC/ACK frame, the base station can send an ACK frame to the cellular telephone over the HARQ channels. Upon successful decoding of the ACK frame, the cellular telephone recognizes that the base station and the cellular telephone are in sync, and the cellular telephone can commence sending packet data.

Each HARQ channel has a retransmission mechanism at the PHY Layer. When the receiving WCD successfully receives and recovers a transmitted sub-packet at the PHY Layer, the receiving WCD can send an ACK signal that indicates the successful recovery of the sub-packet at the PHY Layer. When the receiving WCD does not receive or recover a transmitted sub-packet, the receiving WCD can send a NAK signal that indicates that the SYNC frame was not recovered at the PHY Layer. When the transmitting WCD receives the NAK signal, the transmitting WCD can retransmit the unrecovered sub-packet.

Because there is more than one HARQ logical channel over which sub-packets can be scheduled independently, and because each HARQ logic channel has its own retransmission mechanism, the receiving WCD could receive one or more of the multiple SYNC frames, associated with the initiation of a particular packet data session, out of transmission order and after the initiation of the packet data session between the transmitting WCD and the receiving WCD.

The RLP layer is conventionally reset when an out-of-sequence sync control frame is received by either WCD. The retransmission of sub-packets over the F-PDCH could result in RLP sync frames associated with a particular packet data session being received out of order, causing unnecessary re-syncs.

A need therefore exists to mitigate re-syncs when RLP sync frames associated with the initiation of a particular data session are received out of sequential order.

### BRIEF DESCRIPTION OF THE DRAWINGS

FIG. 1 is a timing diagram of a sync procedure;

FIG. 2 is a flow chart of the method employed by a base station;

FIG. 3 is a flow chart of the method employed by a mobile station; and

FIG. 4 illustrates a block diagram of base station and mobile station in wireless communication system.

### DETAILED DESCRIPTION

To mitigate re-syncs, RLP sync control frames associated with a packet data session can be sequence numbered. A single sequence number can be assigned for an entire sync procedure associated with the initiation of a packet data session. For example, the sequence number can remain the same on all sync control frames (SYNC, SYNC/ACK, ACK) of a particular packet data session. When a sync frame is received out of order within a single sequence, it can be ignored under certain conditions. For example, if a SYNC frame with a sequence number 0 is received out of order after an ACK frame with sequence number 0 is received, the mobile station can ignore the out of order SYNC frame. Thus, an RLP re-sync is avoided due to out of order RLP sync packets.

Because the sequence number can be incremented once every entire RLP sync procedure, the sequence space can be small. A 1-bit sequence number is sufficient to provide a sequence space of 2.

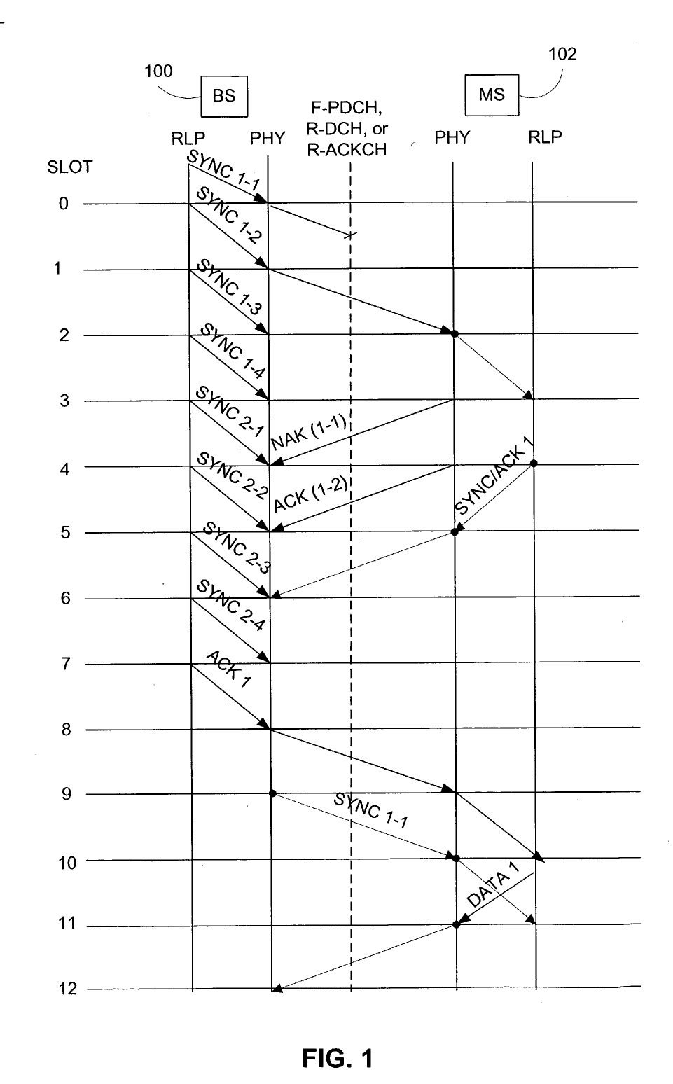

FIG. 1 is a timing diagram of a sync procedure.

In this example of mitigating re-sync of a packet data session between a first WCD and a second WCD at the commencement of the RLP sync procedure over a cdma2000 1xEV-DV system, a base station 100 assigns a sequence number “1” to a first set of four SYNC frames SYNC 1-1, SYNC 1-2, SYNC 1-3, and SYNC 1-4 that are passed from the RLP Layer of the base station to the PHY Layer. The first set of SYNC frames correspond to a first packet data session between the base station 100 and a mobile station 102.

At the PHY Layer, the first set of SYNC frames are encapsulated in a first set of sub-packets sequentially ordered for transmission over the F-PDCH. In this example, only the sub-packets containing SYNC 1-1 and SYNC 1-2 are shown as being transmitted to clarify the illustration. The base station sends the first set of sequentially ordered sub-packets over the F-PDCH using the TDMA HARQ logical channels of the F-PDCH.

In a similar manner, the base station 100 can assign a second sequence number “2” to a second set of SYNC frames SYNC 1-1, SYNC 1-2, SYNC 1-3, and SYNC 1-4. The second set of SYNC frames can correspond to a second packet data session between the base station and a second mobile station (not shown). The base station can send a second set of sub-packets, sequentially ordered for transmission, encapsulating the second set of SYNC frames

The mobile station 102 can receive a first subset of the transmitted first set of sequentially ordered sub-packets. In this particular example, the mobile station does not receive SYNC 1-1, and the mobile station receives SYNC 1-2.

The PHY Layer retransmission mechanism sends an ACK signal or a NAK signal corresponding to each sent SYNC frame over the R-ACKCH. In this example, the mobile station 102 sends a NAK (1-1) corresponding to the non-receipt, or not recovered, SYNC 1-1 at a time of two slots after the expected receipt of SYNC 1-1. Further, the mobile station 102 sends an ACK (1-2) corresponding to the successful recovery of SYNC 1-2 at a time of two slots after the expected receipt of SYNC 1-2.

The mobile station 102 can attempt to decode the received first subset of the first set of sequentially ordered sub-packets. The mobile station can send a SYNC/ACK frame for a sub-packet of the received first subset of the first set of sequentially ordered sub-packets that is successfully decoded. In this example, SYNC/ACK 1, corresponding to SYNC 1-2, is passed from the RLP Layer of the mobile station to the PHY Layer of the mobile station. Before transmission over a reverse fundamental channel (R-FCH), or an equivalent reverse link channel, the SYNC/ACK frame is assigned the first sequence number of “1” corresponding to the recovered SYNC 1-2.

Base station 100 can receive the sent SYNC/ACK 1 and pass it to the RLP Layer. In response to receipt of SYNC/ACK 1, the base station can send an ACK frame ACK 1 over an HARQ logic channel. The ACK frame is assigned the first sequence number “1” before transmission.

The mobile station 102 can receive the sent ACK 1 and pass ACK 1 to the RLP layer. At this time, packet data DATA 1 can sent by the mobile station to the base station 100 over a reverse link channel, such as the R-FCH, a reverse dedicated control channel (R-DCCH), or a reverse supplemental channel (R-SCH). The base station can also send packet data to the mobile station during the data packet session over the F-PDCH.

In this example, SYNC 1-1 is retransmitted at the PHY Layer of the base station in response to receipt of the NAK (1-1).

The mobile station 100 can identify sub-packets of the received first subset of the transmitted first set of sequentially ordered sub-packets that are received after receipt of the ACK frame. With the knowledge that an ACK frame with a sequence number “1” has been received by the mobile station, the mobile station can ignore SYNC frames of a same sequence number, such as SYNC 1-1, that are retransmitted and received after the receipt of an ACK frame of the same sequence number. The mobile station will not re-sync in response to the identified sub-packets

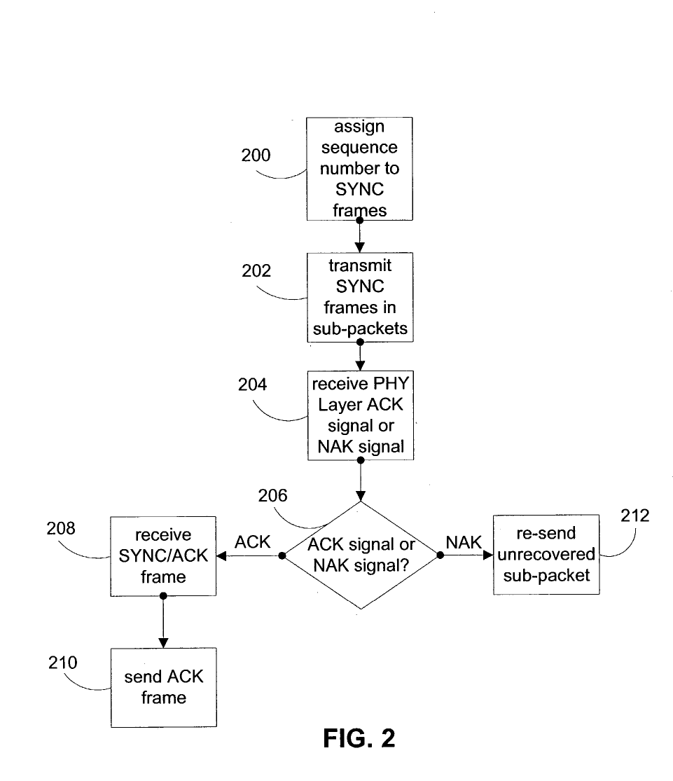

FIG. 2 is a flow chart of the method employed by the base station.

At 200, the base station 100 assigns a sequence number to SYNC frames associated with a particular packet data session. At 202 he base station sequentially transmits the sub-packets encapsulating the SYNC frames over the F-PDCH. At 204, the base station receives an ACK signal or a NAK signal corresponding the transmitted sub-packets. At 206, the base station, at the PHY Layer, determines if the ACK signal or the NAK signal is received.

If the base station determines that an ACK signal corresponding to successful receipt of a SYNC frame by the mobile station is received at 206, typically the base station will receive a SYNC/ACK frame corresponding to a SYNC/ACK frame of a particular sequence number at 208. At 210, the base station will in turn send an ACK frame having the particular sequence number in return.

If the base station receives a NAK signal corresponding to unsuccessful receipt or recovery of a sub-packet containing a SYNC frame at 206, the base station can resend the unrecovered sub-packet containing the SYNC frame at 212.

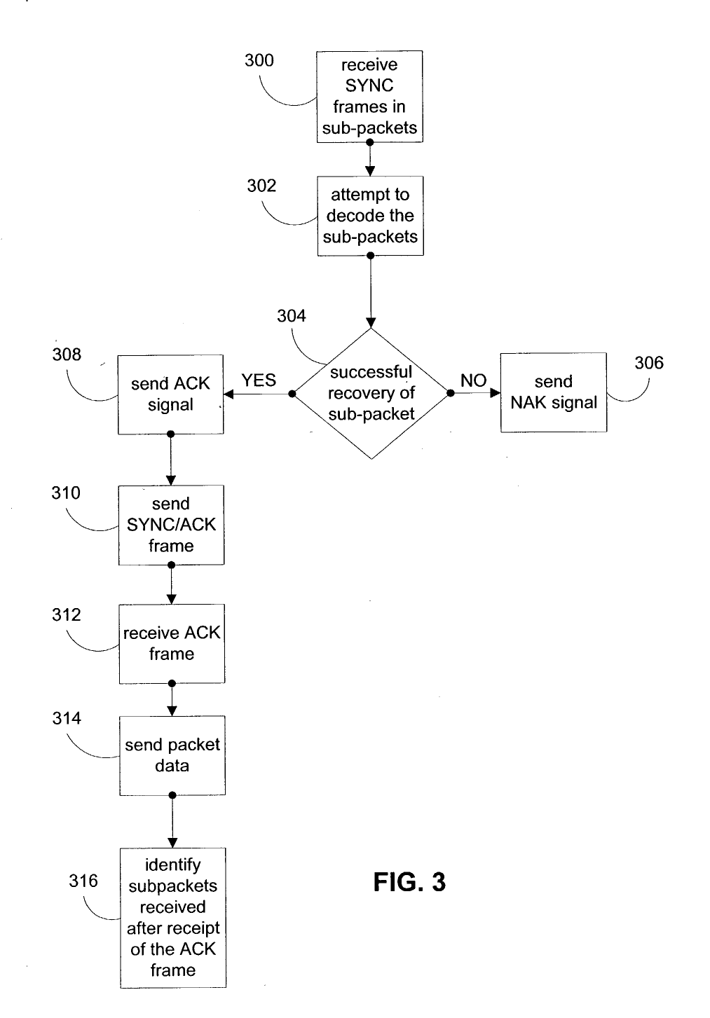

FIG. 3 is a flow chart of the method employed by a mobile station.

At 300, the mobile station receives the sub-packets of the SYNC frames. At 302, the mobile station attempts to decode the sub-packets. At 304, the mobile station determines if the sub-packets have been successfully recovered or not received. If the sub-packet has not been recovered or received, the retransmission mechanism of the mobile station sends a NAK signal at 306. If the sub-packet has been recovered or received, the retransmission mechanism of the mobile station sends an ACK signal at 308.

At 310, the mobile station can send a SYNC/ACK frame having a sequence number corresponding to the particular sequence number of the recovered SYNC frame.

At 312, the mobile station can receive an ACK frame corresponding to the particular sequence number of the recovered SYNC frame.

At 314, the mobile station can commence sending packet data.

At 316, the mobile station identifies sub-packets received after the receipt of the ACK frame and having the same sequence number of the ACK frame. The mobile station will not resync on these identified sub-packets containing retransmitted SYNC frames sent out of sequence and after receipt of the ACK frame.

It will be appreciated that multiple SYNC frames and sub-packets will be sent by the base station, and multiple ACK signals and multiple NAK signals will be received by the base station, corresponding to multiple packet data sessions between the base station and multiple mobile stations. Thus, the order of the blocks in the flow charts are not meant to imply any certain order for executing the functionality.

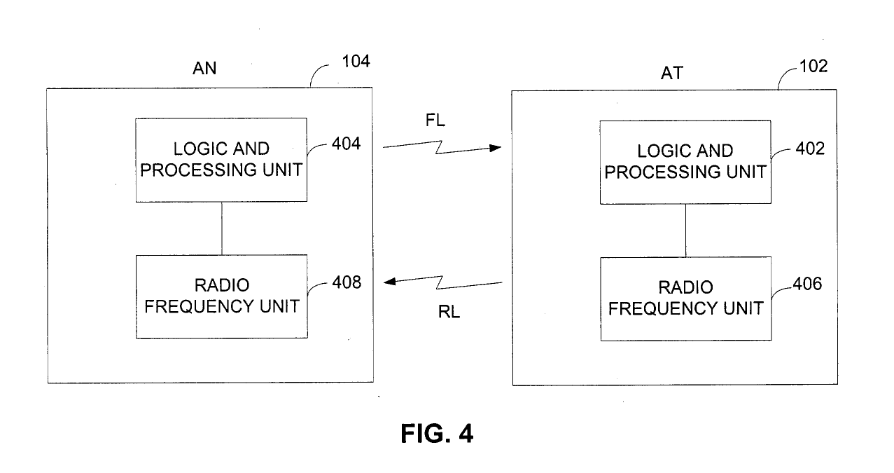

FIG. 4 illustrates a block diagram of base station 100 and mobile station 102 in wireless communication system. The base station and the mobile station can employ conventional hardware and software techniques. Both the base station and the mobile station can comprise a logic and processing unit 402 or 404, respectively, and a radio frequency unit 406 and 408, respectively, for carrying out the above-described functionality. For example, one of ordinary skill in the art will appreciate that the radio frequency units can send and receive signals between the base station and the mobile station, and that the logic and processing units can perform the logical operations and processing of signals.

Although the foregoing description was made with specific reference to the 1xEV-DV communication system, the sync procedure can also be utilized in other CDMA systems.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of mitigating re-sync of a packet data session between a first wireless communication device (WCD) and a second WCD, the method comprising:
assigning a first sequence number to a first set of SYNC frames, wherein the first set of SYNC frames correspond to a first packet data session between the first WCD and the second WCD, and wherein the first set of SYNC frames are encapsulated in a first set of sub-packets sequentially ordered for transmission;
sending, by the first WCD, the first set of sequentially ordered sub-packets;
receiving, by the second WCD, a first subset of the transmitted first set of sequentially ordered sub-packets;
attempting to decode, by the second WCD, the received first subset of the first set of sequentially ordered sub-packets;
sending, by the second WCD, a SYNC/ACK frame for a sub-packet of the received first subset of the first set of sequentially ordered sub-packets that is successfully decoded, wherein the SYNC/ACK frame is assigned the first sequence number;
receiving, by the first WCD, the sent SYNC/ACK frame;
sending, by the first WCD, an ACK frame in response to receipt of the SYNC/ACK signal, wherein the ACK frame is assigned the first sequence number;
receiving, by the second WCD, the sent ACK frame;
identifying, by the second WCD, according to the first sequence number, sub-packets of the received first subset of the transmitted first set of sequentially ordered sub-packets that are received after receipt of the ACK frame; and
not re-syncing in response to the identified sub-packets of the received first subset of the transmitted first set of sequentially ordered sub-packets.

2. The method of claim 1 further comprising:
assigning a second sequence number to a second set of SYNC frames, wherein the second set of SYNC frames correspond to a second packet data session between the first WCD and a third WCD, and wherein the second set of SYNC frames are encapsulated in a second set of sub-packets sequentially ordered for transmission;
sending, by the first WCD, the second set of sequentially ordered sub-packets; and
receiving, by the third WCD, a second subset of the transmitted second set of sequentially ordered sub-packets.

3. The method of claim 1 further comprising:
sending, by the second WCD, a NAK signal for a sub-packet of the received first subset of the first set of sequentially ordered sub-packets that is not unsuccessfully decoded; and
receiving, by the second WCD, the sent NAK signal.

4. The method of claim 1 further comprising:
sending, by the second WCD, packet data between the first WCD and the second WCD after receipt of the ACK frame.

5. A method of mitigating re-sync of a packet data session by a wireless communication device (WCD), the method comprising:
receiving a first subset of a first set of sub-packets, wherein a first set of SYNC frames are encapsulated in the first set of sub-packets, a first sequence number is assigned to the first set of SYNC frames, and the first set of SYNC frames correspond to a first packet data session;
attempting to decode the received first subset of the first set of sub-packets;
sending a SYNC/ACK frame for a sub-packet of the received first subset of the first set of sub-packets that is successfully decoded, wherein the SYNC/ACK frame is assigned the first sequence number;
receiving an ACK frame having the first sequence number;
identifying, according to the first sequence number, sub-packets of the received first subset of the first set of sub-packets that are received after receipt of the ACK frame; and
not re-syncing in response to the identified sub-packets of the received first subset of the transmitted first set of sequentially ordered sub-packets.

6. The method of claim 5 further comprising:
sending packet data after receipt of the ACK frame.
